(19) United States
(12) Patent Application Publication
(10) Pub. No.: US 2014/0238505 A1
(43) Pub. Date: Aug. 28, 2014

(54) VALVE COMPRISING A RESILIENT VALVE ELEMENT

(71) Applicant: Lars Petersen, Hadsun (DK)

(72) Inventor: Lars Petersen, Hadsun (DK)

(73) Assignee: ILLINOIS TOOL WORKS INC., Glenview, IL (US)

(21) Appl. No.: 14/351,461

(22) PCT Filed: Aug. 27, 2012
(86) PCT No.: PCT/EP2012/066595

§ 371 Date: Apr. 11, 2014

(30) Foreign Application Priority Data
Oct. 13, 2011 (DK) PA 2011 70568

(51) Int. Cl. F16K 15/20

(52) U.S. Cl. CPC F16K 15/202
USPC 137/223; 137/852

(57) ABSTRACT

The present disclosure provides a valve comprising a flange part and a valve element. The flange part comprises a tubular section defining an axial direction. The valve element is made of resilient material and mounted in the tubular section of the flange part. One or more cut-outs are formed in a side wall of the valve element. At least part of the side wall is arranged in abutment with an inner wall of the tubular section. When a force is applied along the axial direction, the valve element stretches, causing the cut-outs to move at least partly out of the tubular section. This establishes a fluid connection through the flange part via the cut-outs, opening the valve. When the force is removed, the valve element resumes its relaxed state, restoring its shape and size and moving the cut-outs into the tubular section, interrupting the fluid connection and closing the valve.

### PRIORITY CLAIM

This application is a national stage application of PCT/EP2012/066595, filed on Aug. 27, 2012, which claims priority to and the benefit of Denmark Patent Application No. PA 2011 70568, filed on Oct. 13, 2011, the entire contents of each of which are incorporated herein by reference.

### FIELD

The present disclosure relates to a valve comprising a flange part and a resilient valve element. The valve of the present disclosure is particularly suitable for use in a container comprising flexible walls, such as a bag, a sack or the like. In this case the container may be inflated via the valve, using a source of pressurized fluid, and/or deflated via the valve. Such bags or sacks may, e.g., be used for stabilizing goods during transit. In this case the bag or sack is inserted between pieces of goods in a deflated state, and inflated in this position. Thereby the inflated bag or sack is arranged firmly against the goods, and prevents the goods from shifting during transport.

### BACKGROUND

International Publication No. WO 94/06695 discloses a closure for sacks, bags or the like containers with non-rigid walls. The containers are pressurized. The closure comprises a filling nozzle with a valve and a flange. The flange has a cylindrical portion and a plate shaped portion. The plate shaped portion of the flange is attached to the container. The filling nozzle may be caused to sealingly engage the flange by a snap connection, whereby the closure is either completely open or closed.

International Publication No. WO 98/16767 discloses an inflation valve for sacks, bags or the like containers. The containers are pressurized, in one embodiment with air pressure. The inflation valve comprises a flange formed of a tubular part with a circular cylindrical opening and a plate-shaped part with which the flange is secured to the container. The inflation valve further comprises a filling nozzle adapted to be arranged in sealing engagement in the opening of the tubular parts by a snap connection. The filling nozzle may pivot freely in the opening and forms part of a valve body. A gas supply passage is adapted to receive a gas supply tube, one end thereof being adapted to mechanically open a valve flap at the insertion of the gas supply tube. The flap is mounted inside the valve body and normally keeps the gas supply passage closed due to elastic material or mounting of the valve flap.

U.S. Pat. No. 5,285,805 discloses a stretch valve which achieves precise control of fluid flow rates through the use of a cylindrical elastomeric valve element. This elastomer valve element is installed within the cylindrical flow path of a valve body. The flow path has a diameter that is slightly smaller than that of the elastomer element, which is therefore constrained within the flow path. Longitudinal stretching of the elastomer element causes the diameter of the elastomer element to decrease. As a result, a flow path is opened.

### SUMMARY

It is an advantage of embodiments of the present disclosure to provide a valve comprising fewer parts than prior art valves.

It is a further advantage of embodiments of the present disclosure to provide a valve which is easier to assemble than prior art valves.

It is an even further advantage of embodiments of the present disclosure to provide a valve which can be mounted on a container using an assembly process requiring fewer steps than prior art valves.

It is an even further advantage of embodiments of the present disclosure to provide a valve which provides a high flow rate in an open position while providing efficient sealing in a closed position.

According to a first aspect the present disclosure provides a valve comprising: a flange part comprising a tubular section defining an axial direction, and a valve element mounted in the tubular section of the flange part, the valve element being made from a resilient material, and the valve element being provided with one or more cut-outs formed in a side wall of the valve element, at least part of the side wall being arranged in abutment with an inner wall of the tubular section of the flange part, the inner wall extending along the axial direction, wherein the valve element is adapted to stretch in response to a force applied along the axial direction of the tubular section, in such a manner that the one or more cut-outs is/are moved at least partly out of the tubular section, thereby establishing a fluid connection through the flange part, via the one or more cut-outs, and wherein the valve element is adapted to resume a relaxed state, restoring its shape and size, when the force is no longer applied, thereby moving the one or more cut-outs into the tubular section, thereby interrupting the fluid connection through the flange part.

In the present context the term ‘valve’ should be interpreted as an object which is capable of selectively enabling a fluid flow through the object or preventing such a fluid flow.

The valve comprises a flange part and a valve element. The valve element is mounted in a tubular section of the flange part. In the present context the term ‘tubular section’ should be interpreted as a section of the flange part which has a substantially tubular shape, i.e., the shape of a tube. Thus, the tubular section comprises a wall enclosing an inner cavity, the wall defining a cross sectional shape and size which is substantially invariant along an axial direction of the tubular section. The tubular section may, e.g., have a cylindrical shape, in which case the cross sectional shape defined by the wall is a circle. As an alternative, the side wall may define any other suitable cross sectional shape. An inner surface of the wall faces the inner cavity. The wall, and thereby also the inner surface of the wall, extends along the axial direction.

The valve element is made from a resilient material. Thereby the shape of the valve element can be altered by applying a force to the valve element. However, the valve element restores its original shape, i.e., the valve element resumes a relaxed state, when the force is no longer applied. In the present context the term ‘valve element’ should be interpreted as an element which defines whether the valve is in an open or a closed position, possibly in cooperation which one or more other parts of the valve.

The valve element is provided with one or more cut-outs or openings formed in a side wall of the valve element. The cut-outs each provides a passage through the side wall. The cut-out may, e.g., be provided by removing material from the valve element, e.g., by cutting, punching or stamping. As an alternative, the cut-outs may be formed directly in the side wall of the valve element during manufacture of the valve element. This may, e.g., be the result of a moulding process, such as an injection moulding process, depending on the material used for the valve element.

At least a part of the side wall of the valve element is arranged in abutment of an inner wall of the tubular section. Accordingly, at least a part of the side wall follows the tubular shape of the inner wall of the tubular section. In certain embodiments, the side wall of the valve element has a tubular shape, the side wall thereby being arranged in abutment with the inner wall of the tubular section along the entire periphery defined by the tubular section of the flange part. Since the side wall of the valve element is arranged in abutment with the inner wall of the tubular section of the flange part, sealing is provided between the side wall and the inner wall. When the cut-outs are arranged in the part of the side wall which is arranged in abutment with the inner wall, fluid flow through the side wall of the valve element, via the cut-outs, is prevented. On the other hand, if one or more cut-outs are arranged at least partly in a part of the side wall which is not arranged in abutment with the inner wall of the tubular section, the provided sealing does not prevent a fluid flow through the side wall, via the cut-out(s).

The valve element is adapted to stretch in response to a force applied along the axial direction of the tubular section of the flange part. This may be purely a result of the resilient properties of the material of the valve element. When the valve element is stretched in this manner, the one or more cut-outs is/are moved at least partly out of the tubular section, i.e., when the valve element is in the stretched state, the cut-outs are no longer in the ‘sealing section’ as described above, and a fluid connection is thereby established through the flange part, via the cut-outs formed in the side wall of the valve element.

The valve element is further adapted to resume a relaxed state, restoring its original shape and size, when the force is no longer applied, due to the resilient properties of the material of the valve element. Thereby the one or more cut-outs are moved into the tubular section of the flange part. Accordingly, in this situation the cut-outs are arranged in the ‘sealing section’. Therefore fluid flow through the flange part, via the cut-outs of the valve element, is prevented, i.e., the previously established fluid connection through the flange part is interrupted.

Thus, the valve according to the first aspect of the present disclosure can be controlled simply by the applied force. When the force is applied, the valve is in an open position, enabling a fluid flow through the valve, and when the force is not applied, the valve is in a closed position and provides sealing. This is very simple without compromising the sealing properties of the valve. Furthermore, the valve can be assembled simply by mounting the valve element in the tubular section of the flange part, i.e., the valve requires only one process step, which can easily be fitted into a general manufacturing process of an item, e.g., a container, such as a bag, sack or the like. Finally, the valve may only require two parts, i.e., the flange part and the valve element, which are assembled.

The valve element may be provided with at least two cut-outs, and the cut-outs may be arranged substantially equidistantly on the side wall, along an annular direction. According to this embodiment, the cut-outs are evenly distributed along the annular or peripheral part of the tubular section. Thereby the fluid flow through the valve, when the valve is in the open position, is also distributed substantially evenly along the annular or peripheral direction, provided that the cut-outs are of substantially uniform size. This may be advantageous for some applications.

The valve element may further comprise a sealing lip, the sealing lip being arranged in abutment with a sealing edge of the flange part when the valve element is in the relaxed state, and the sealing lip being arranged at a distance from the sealing edge when the valve element is in the stretched state. According to this embodiment, the sealing lip of the valve element and the sealing edge of the flange part in combination provide additional sealing for the valve when the valve is in the closed position. The sealing edge may advantageously be arranged annularly at an end portion of the tubular section of the flange part. In this case the sealing lip may, similarly, be arranged annularly on an outer surface of the side wall of the valve element.

In addition, further sealing arrangements between the flange part and the valve element may be provided in order to provide efficient sealing of the valve when the valve is in the closed position.

The valve element may be adapted to stretch in response to a force applied by a pressurized fluid. The pressurized fluid is, in certain embodiments, a pressurized gas. However, it is not ruled out that the pressurized fluid could be a liquid or a mixture of gas and liquid. The pressurized fluid may advantageously be a fluid which shall pass through the valve when the valve is in an open position, for instance with the purpose of inflating a flexible wall container having the valve mounted thereon. According to this embodiment, the valve may be operated in the following manner. When it is desired to pass fluid through the valve, e.g., in order to inflate a container, pressurized fluid is simply supplied to the valve. The force generated by the pressurized fluid causes the valve element to stretch, thereby opening the valve as described above, enabling pressurized fluid to pass through the valve. When it is no longer desired to enable fluid to pass the valve, e.g., because a container has been fully inflated, the supply of pressurized fluid is simply stopped or interrupted. Thereby the force which was previously applied to the valve element by the pressurized fluid is no longer applied. As a consequence, the valve element resumes its relaxed state, thereby restoring its original size and shape, and the part of the side wall having the cut-outs formed therein is moved into abutment with the inner wall of the tubular section of the flange part, thereby closing the valve. In the case that the valve is mounted on or forms part of an inflatable container, this ensures that the fluid used for inflating the container may not leave the container via the valve, i.e., the container remains inflated.

The flange part may be provided with an interface part enabling a source of pressurized fluid to be connected to the valve. The interface part may enable relative angular movements between the valve and the source of pressurized fluid. According to this embodiment, the relative angular position between the valve and the source of pressurized fluid can be selected to match any suitable requirement. For instance, the valve may be arranged in a region with difficult accessibility conditions, where it is desirable to position a source of pressurized fluid in such a manner that the source of pressurized fluid can be operated manually while it the source of pressurized fluid is attached to the valve. This may, e.g., be the case if the valve is mounted on or forms part of an inflatable bag or sack which is positioned between transfer goods in a cargo container in order to prevent the goods from shifting during transport. Since such bags or sacks are arranged between the goods and subsequently inflated, the valve of a designated bag or sack may not be readily accessible, and it is therefore an advantage that the source of pressurized fluid can easily be oriented in a manner which enables the source of pressurized fluid to be manually operated in order to inflate the bag or sack.

The source of pressurized fluid may comprise a nozzle part matching the interface part of the flange part. The nozzle part and the interface part may advantageously cooperate in such a manner that a substantially fluid tight connection is established between the source of pressurized fluid and the valve. This enables pressurized fluid to be supplied to and flow through the valve in a safe and efficient manner. The nozzle part and the interface part may, e.g., be connectable by a click system, via a threaded connection, via a clamping system, or in any other suitable manner. In certain embodiments, the nozzle part and the interface part can easily be connected and disconnected.

The valve element may be provided with an annular recess, and the interface part may be arranged to engage the recess in such a manner that a source of pressurized fluid connected to the interface part presses the valve element against the interface part. According to this embodiment, when a force is applied to the valve element by the pressurized fluid, the part of the valve element where the annular recess is arranged is pressed against the interface part. Thereby this part of the valve element is retained between the source of pressurized fluid and the interface part. It is thereby avoided that the force applied by the pressurized fluid presses the valve element through the tubular section of the valve part, and a reliable operation of the valve is obtained.

The valve element may extend beyond the interface part along the axial direction. According to this embodiment the resilient valve element forms a boundary between the source of pressurized fluid and the valve. The resilient properties of the valve element provides sealing to this boundary.

The valve element may be made from an elastomer, such as a silicone, a thermoplastic rubber, or any other suitable kind of elastomer. Silicone is one example material for the valve element, because silicone is normally easily stretched, and because the elastic properties and the stability of silicone are substantially invariant over a very large temperature span, covering normally expected temperatures in a cargo container on board a freight ship.

The flange part may further comprise a plate shaped section arranged substantially perpendicularly to the axial direction of the tubular section. The plate shaped section may advantageously be used for mounting or attaching the valve on an item, e.g., an inflatable container.

The flange part may be mountable onto an additional flange which can be mounted on a flexible wall container, such as a bag or a sack. The flange part, carrying the valve element, may be mountable onto the additional flange in such a manner that a passage to the interior of the container can be opened or closed by a single operation, detaching or attaching the flange part from the additional flange. This may, e.g., be obtained by a snap connection. According to this embodiment, a high deflation rate can easily be obtained by detaching the flange part from the additional flange, thereby opening the passage to the interior of the container. This enables the container to be reused, since the container can easily be deflated by opening the passage, and the passage can easily be closed afterwards by mounting the flange part onto the additional flange part, thereby enabling the container to be inflated once again via the valve, as described above.

According to a second aspect the present disclosure provides a container comprising flexible walls and a valve according to the first aspect of the present disclosure, the valve being arranged in such a manner that the valve defines a fluid passage between the interior of the container and the exterior when the valve is in an open position, and seals the container when the valve is in a closed position.

Thus, the container according to the second aspect comprises a valve as described above. Accordingly, the remarks set forth above are equally applicable here. The container may, e.g., be of a kind which is arranged between goods in a cargo container in order to prevent the goods from shifting during transport. When the valve is in the open position the container may be inflated or deflated via the valve. When the valve is in the closed position the container is sealed, i.e., if the container is in an inflated state, deflation of the container is prevented as long as the valve remains in the closed position. If it is desired to deflate the container, a force may be applied to the valve member, e.g., a mechanical force, thereby moving the valve to the open position and enabling inflation fluid to pass from the interior of the container to the exterior, or an additional flange as described above may be provided in order to enable a passage to be easily formed to the interior of the container. This enables the container to be reused. As an alternative, an incision may be cut in a wall of the container when it is desired to deflate the container, if the container is not to be reused.

As described above, the cut-outs of the valve element are arranged on a side wall of the valve element. In the case that the valve is mounted on the container in such a manner that the axial direction of the tubular section of the flange part is substantially perpendicular to a surface defined by a wall of the container having the valve mounted thereon, then fluid flow through the cut-outs is substantially parallel to the surface of the wall of the container having the valve mounted thereon. This is an advantage because it is thereby prevented that inflation fluid is blocked by an opposing wall of the container during the initial phase of the inflation. Furthermore, the risk that vibrations occur in the opposing wall of the container during inflation is minimised. In the case that the wall is lined with a film, such vibrations may cause the film to break, thereby potentially causing the container to leak.

According to a third aspect the present disclosure provides a valve element for a valve according to the first aspect of the present disclosure, the valve element defining an inner cavity delimited by a substantially tubular side wall and a substantially closed first end part, the valve element further comprising a second end part arranged opposite the first end part, an opening being arranged at or near the second end part, the opening establishing a fluid connection between the inner cavity and the exterior, wherein the side wall is provided with one or more cut-outs, each cut-out establishing a fluid connection between the inner cavity and the exterior.

It should be noted that a person skilled in the art would readily recognise that any feature described in combination with the first aspect of the present disclosure could also be combined with the second or third aspects of the present disclosure, that any feature described in combination with the second aspect of the present disclosure could also be combined with the first or third aspects of the present disclosure, and that any feature described in combination with the third aspect of the present disclosure could also be combined with the first or second aspects of the present disclosure.

The valve element according to the third aspect of the present disclosure is for a valve according to the first aspect of the present disclosure, and the remarks set forth above are therefore equally applicable here.

Since the opening establishes a fluid connection between the inner cavity and the exterior, and each cut-out establishes a fluid connection between the inner cavity and the exterior, fluid may enter the inner cavity via the opening and leave the inner cavity via the cut-out(s), or vice versa, thereby enabling a fluid flow through the valve element, via the inner cavity.

The valve element is adapted to be mounted in the flange part of a valve according to the first aspect of the present disclosure in such a manner that an outer surface of the tubular side wall is arranged in abutment with the inner wall of the tubular section of the flange part. When the cut-outs are arranged in a region of the tubular side wall which is in abutment with the inner wall of the tubular section of the flange part, fluid flow through the valve element, via the inner cavity, is prevented, due to the substantially closed first end part. Thus, the valve is closed in this situation. However, when the cut-outs are at least partly arranged in a region of the tubular side wall which is not in abutment with the inner wall of the tubular section of the flange part, fluid flow through the valve element, via the inner cavity, is enabled, in the manner described above. Thus, the valve is open in this situation. The valve can be operated between open and closed positions by shifting the region of the tubular side wall comprising the cut-outs between a position in which the region is in abutment with the inner wall of the tubular section of the flange part and a position in which at least part of the region is not in abutment with the inner wall of the tubular section of the flange part.

The valve element may be provided with at least two cut-outs, and the cut-outs may be arranged substantially equidistantly on the side wall, along an annular direction. As described above with reference to the first aspect of the present disclosure, this arrangement of the cut-outs ensures that the fluid flow through the valve, when the valve is in the open position, is distributed substantially evenly along the annular or peripheral direction, provided that the cut-outs are of substantially uniform size.

The valve element may further comprise a sealing lip arranged between the cut-out(s) and the first end part. According to this embodiment, the sealing lip may be moved into abutment with a sealing edge of a flange part in which the valve element is mounted, when the region of the tubular side wall which comprises the cut-outs is arranged in abutment with the inner side wall of the tubular section of the flange part. As described above, this improves the sealing properties of the valve comprising the valve element.

The valve element may be made from a resilient material, e.g., an elastomer, such as a silicone, a thermoplastic rubber, etc. According to this embodiment, the region of the tubular side wall comprising the cut-out can be moved between a position in which the region is in abutment with an inner wall of a flange part, and a position in which at least part of the region is not in abutment with the inner wall, by applying a force to the valve element, causing the valve element to stretch.

Additional features and advantages are described herein, and will be apparent from, the following Detailed Description and the Figures.

### BRIEF DESCRIPTION OF THE DRAWINGS

The present disclosure will now be described in further detail with reference to the accompanying drawings, in which

FIGS. 1 and 2 illustrate a valve according to a first embodiment of the present disclosure in a closed position,

FIGS. 3 and 4 illustrate the valve of FIGS. 1 and 2 in an open position,

FIGS. 5 and 6 illustrate a valve according to a second embodiment of the present disclosure in a closed position,

FIGS. 7 and 8 illustrate the valve of FIGS. 5 and 6 in an open position, and

FIGS. 9, 10, 11, and 12 show a valve element for the valve of FIGS. 1 to 4, or for the valve of FIGS. 5 to 8.

### DETAILED DESCRIPTION

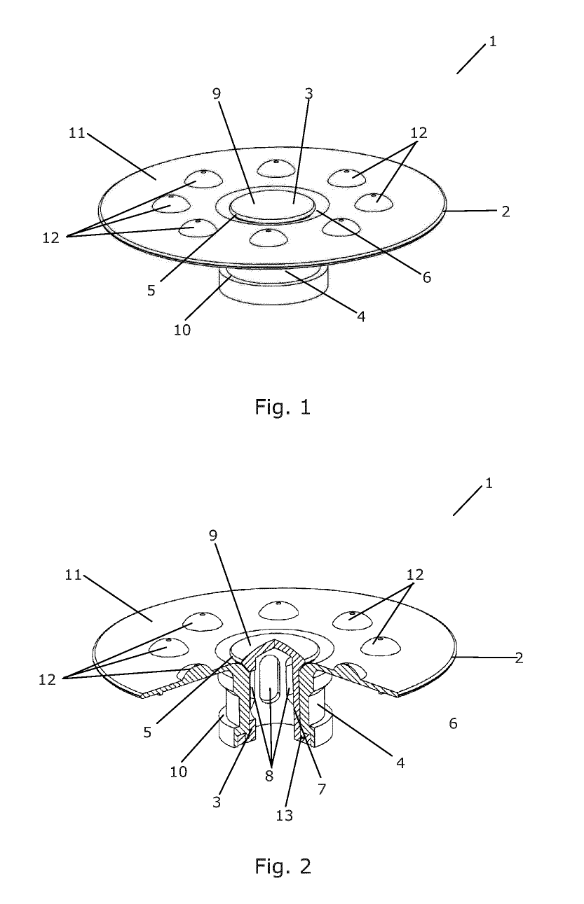

Referring now to the example embodiments of the present disclosure illustrated in FIGS. 1 to 12, FIG. 1 is a perspective view of a valve 1 according to a first embodiment of the present disclosure. The valve 1 comprises a flange part 2 and a valve element 3 mounted in a tubular section 4 of the flange part 2. The valve element 3 comprises a sealing lip 5 which, in FIG. 1, is arranged in abutment with a sealing edge 6 of the flange part 2. This prevents fluid from flowing through the valve 1, via the tubular section 4, i.e., the valve 1 is in a closed position.

FIG. 2 is a partly perspective and partly cross sectional view of the valve 1 of FIG. 1. In FIG. 2 it can be seen that the valve element 3 comprises a side wall 7 which is arranged in abutment with an inner wall of the tubular section 4 of the flange part 2. The side wall 7 is provided with a quantity of cut-outs 8 arranged circumferentially along the side wall 7. Each of the cut-outs 8 defines a passage through the side wall 7.

In FIG. 2 it can also be seen that the sealing lip 5 of the valve element 3 is arranged in abutment with the sealing edge 6 of the flange part 2, thereby preventing fluid passage between the sealing lip 5 and the sealing edge 6. Since the valve element 3 is further provided with a closed end part 9, fluid passage through the valve 1, via the tubular section 4 of the flange part 2, is efficiently prevented.

The tubular section 4 of the flange part 2 is provided with an annular edge 10 forming an interface towards a source of pressurized fluid (not shown). The annular edge 10 enables the source, e.g., in the form of a nozzle, to be easily mounted on the valve 1 in a secure manner. Furthermore, since the edge 10 is annularly arranged on the tubular section 4, the source of pressurized fluid is enabled to rotate relative to the valve 1, i.e., a suitable orientation of the source of pressurized fluid relative to the valve 1 can be selected, as described above. Thereby pressurized fluid, such as pressurized air, can be supplied to the interior part of the valve element 3. This will be described in further detail below.

The valve element 3 is made from a resilient material, e.g., an elastomer, such as a silicone. Thereby the valve element 3 is adapted to stretch when a force is applied to the valve element 3, and to resume a relaxed state, i.e., restoring an original shape and size, when the force is no longer applied. This will also be described in further detail below. In FIGS. 1 and 2 the valve element 3 is in its relaxed state.

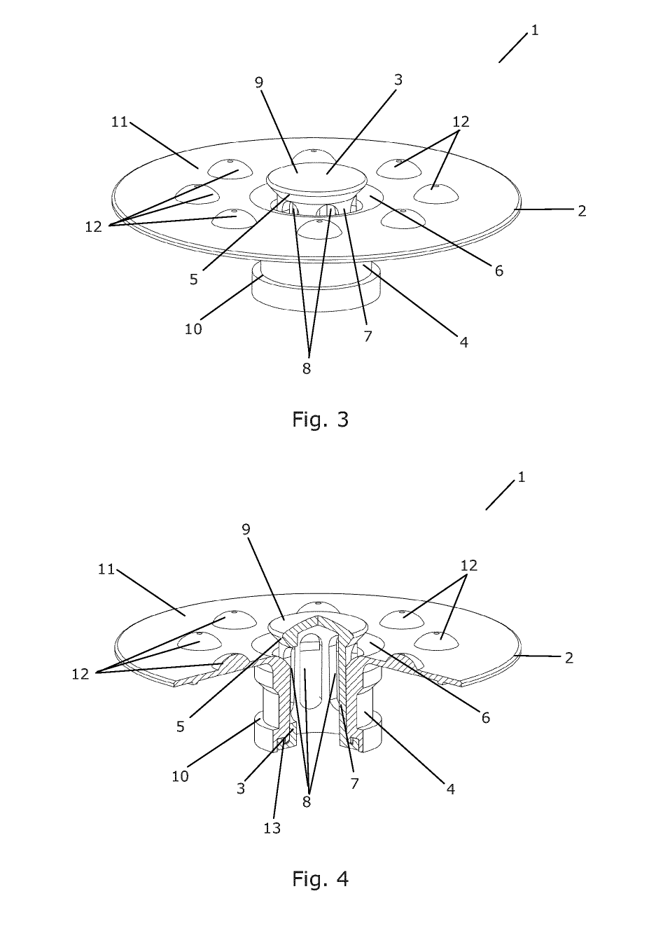

FIG. 3 is a perspective view of the valve 1 of FIGS. 1 and 2. In FIG. 3 a force has been applied to the valve element 3, and the valve element 3 has thereby been stretched in such a manner that the sealing lip 5 of the valve element 3 no longer abuts the sealing edge 6 of the tubular section 4 of the flange part 2. Furthermore, the side wall 7 of the valve element 3 has been stretched in such a manner that part of the cut-outs 8 are no longer arranged in the tubular section 4 of the flange part 2. Accordingly, fluid passages are defined through the valve 1, via the tubular section 4 and the cut-outs 8. Thus, the valve 1 is in an open position.

The force applied to the valve element 3 may be applied by a pressurized fluid, such as pressurized air. In this case a source of pressurized fluid, e.g., a nozzle, is attached to the tubular section 4 of the flange part 2 at the annular edge 10. The pressure of the pressurized fluid then stretches the valve element 3, thereby opening the valve 1 as described above. Furthermore, the pressurized fluid flows through the valve 1, via the tubular section 4 and the cut-outs 8. Thus, when it is desired to pass fluid through the valve 1, e.g., in order to inflate a container with flexible walls, the pressurized fluid is simply applied to the valve 1 as described above, thereby simultaneously opening the valve 1 and passing fluid through the valve 1. When it is no longer desired to pass fluid through the valve 1, e.g., because the container is fully inflated, the source of pressurized fluid is simply removed. Thereby the force applied to the valve element 3 due to the pressure of the pressurized fluid is removed, and the valve element 3 resumes its relaxed state, thereby closing the valve 1 and preventing a back flow of fluid through the valve 1.

FIG. 4 is a partly perspective and partly cross sectional view of the valve 1 of FIG. 3. In FIG. 4 it is clearly seen that the valve element 3 is stretched and the cut-outs 8 are moved out of the tubular section 4.

In FIGS. 1 to 4 it can be seen that the flange part 2 comprises a plate shaped section 11. The plate shaped section 11 enables the valve 1 to be attached to a wall of a container, such as a container with flexible walls, in such a manner that the valve 1 provides fluid passage to the interior of the container when the valve 1 is in the open position, and seals the container when the valve 1 is in the closed position.

The plate shaped section 11 is provided with eight bulbous surface sections 12. When the valve 1 is in the open position as shown in FIGS. 3 and 4, pressurized fluid flows sideways out of the cut-outs 8, i.e., in a direction along the plane defined by the plate shaped section 11, and towards the bulbous surface sections 12. This prevents that the fluid flow through the valve 1 is prevented or inhibited by a flexible wall of the container which is arranged opposite to the wall having the valve 1 mounted thereon. The bulbous surface sections 12 divert the fluid flow further, thereby ensuring a fast and efficient inflation of the container.

The valve element 3 is provided with a recess 13 which is arranged in engagement with a part of the tubular section 4 of the flange part 2. Thereby, when a source of pressurized fluid, e.g., in the form of a nozzle, is mounted at the annular edge 10, the nozzle as well as the force provided by the pressurized fluid presses the part of the valve element 3 where the recess 13 is formed against the tubular section 4. Thereby it is prevented that the force applied by the pressurized fluid pushes the valve element 3 through the tubular section 4.

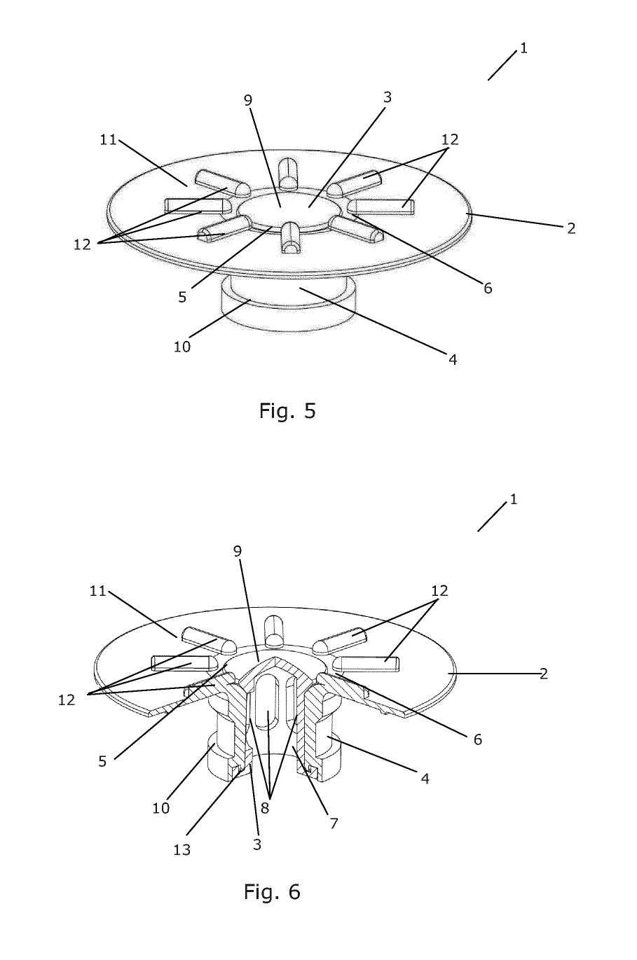

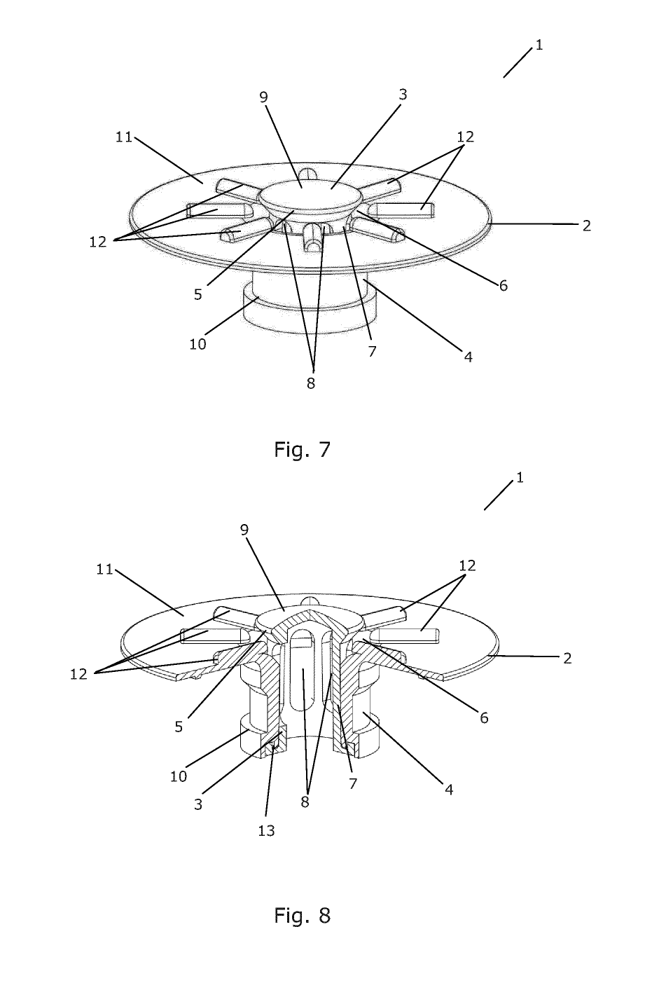

FIGS. 5 to 8 illustrate a valve 1 according to a second embodiment of the present disclosure. FIGS. 5 and 6 show the valve 1 in a closed position, and FIGS. 7 and 8 show the valve 1 in an open position. The valve 1 of FIGS. 5 to 8 is very similar to the valve of FIGS. 1 to 4, and the valve 1 will therefore not be described in detail here.

In the valve 1 of FIGS. 5 to 8 the bulbous surface portions 12 arranged on the plate shaped section 11 of the flange part 2 have an elongated shape, and extend along a substantially radial direction of the plate shaped section 11. This shape of bulbous surface portions 12 ensure that the fluid flow is diverted more efficiently. Furthermore, the bulbous surface portions 12 act as a kind of ribs, providing structural strength to the plate shaped section 11.

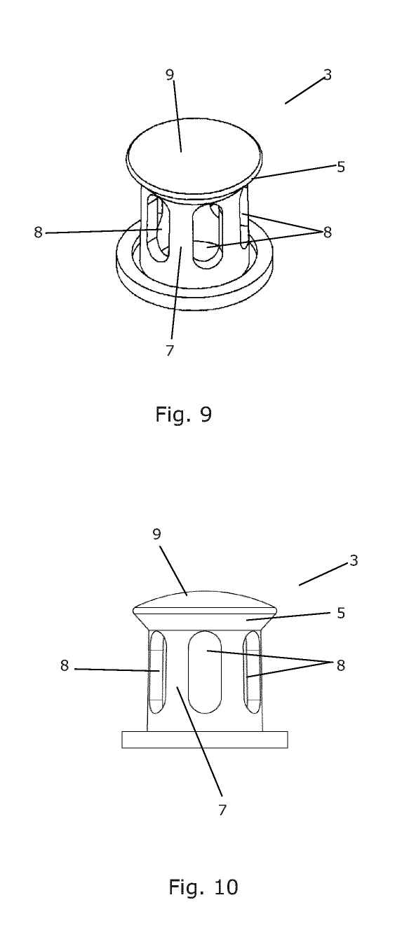

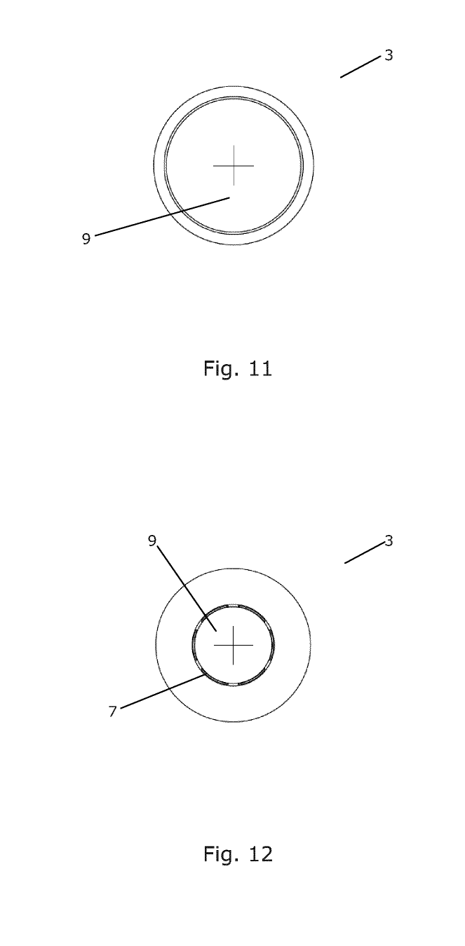

FIGS. 9 to 12 show a valve element 3 for use in the valve 1 of FIGS. 1 to 4, or for the valve 1 of FIGS. 5 to 8. The closed end part 9, the side wall 7 and the cut-outs 8 can be easily seen. FIG. 9 is a perspective view and FIG. 10 is a side view of the valve element 3. FIG. 11 shows the valve element 3 from a direction towards the closed end part 9, and FIG. 12 shows the valve element 3 from an opposite direction, showing the interior part of the valve element 3.

It should be understood that various changes and modifications to the present embodiments described herein will be apparent to those skilled in the art. Such changes and modifications can be made without departing from the spirit and scope of the present subject matter and without diminishing its intended advantages. It is therefore intended that such changes and modifications be covered by the appended claims.

1-16. (canceled)

17: A valve comprising:
(a) a flange part including a tubular section defining an axial direction; and
(b) a valve element mounted in the tubular section of the flange part, said valve element being provided with one or more cut-outs formed in a side wall of the valve element, at least part of said side wall being arranged in abutment with an inner wall of the tubular section of the flange part, said inner wall extending along the axial direction,
wherein the valve element is configured to stretch in response to a force applied along the axial direction of the tubular section, in such a manner that the one or more cut-outs are moved at least partly out of the tubular section, thereby establishing a fluid connection through the flange part, via the one or more cut-outs, and wherein the valve element is configured to resume a relaxed state, restoring its shape and size, when the force is no longer applied, thereby moving the one or more cut-outs into the tubular section, thereby interrupting the fluid connection through the flange part.

18: The valve of claim 17, wherein the valve element is provided with at least two cut-outs, and wherein the cut-outs are arranged substantially equidistantly on the side wall, along an annular direction.

19: The valve of claim 17, wherein the valve element further comprises a sealing lip, said sealing lip being arranged in abutment with a sealing edge of the flange part when the valve element is in the relaxed state, and said sealing lip being arranged at a distance from the sealing edge when the valve element is stretched.

20: The valve of claim 17, wherein the valve element is adapted to stretch in response to a force applied by a pressurized fluid.

21: The valve of claim 17, wherein the flange part is provided with an interface part enabling a source of pressurized fluid to be connected to the valve.

22: The valve of claim 21, wherein the interface part enables relative angular movements between the valve and the source of pressurized fluid.

23: The valve of claim 21, wherein the valve element is provided with an annular recess, and the interface part is arranged to engage said recess in such a manner that a source of pressurized fluid connected to the interface part presses the valve element against the interface part.

24: The valve of claim 21, wherein the valve element extends beyond the interface part along the axial direction.

25: The valve of claim 17, wherein the valve element is made from an elastomer.

26: The valve of claim 17, wherein the flange part further comprises a plate shaped section arranged substantially perpendicularly to the axial direction of the tubular section.

27: The valve of claim 17, the valve element defining an inner cavity delimited by a substantially tubular side wall and a substantially closed first end part, the valve element further comprising a second end part arranged opposite the first end part, an opening being arranged at or near the second end part, said opening establishing a fluid connection between the inner cavity and the exterior, wherein the side wall is provided with one or more cut-outs, each cut-out establishing a fluid connection between the inner cavity and the exterior.

28: The valve of claim 27, wherein the valve element is provided with at least two cut-outs, and wherein the cut-outs are arranged substantially equidistantly on the side wall, along an annular direction.

29: The valve of claim 27, wherein the valve element further comprises a sealing lip arranged between the cut-outs and the first end part.

30: The valve of claim 27, wherein the valve element is made from a resilient material.

31: The valve of claim 30, wherein the valve element is made from an elastomer.

32: A valve comprising:
(a) a flange part including a tubular section defining an axial direction; and
(b) a valve element mounted in the tubular section of the flange part, said valve element being provided with one or more cut-outs formed in a side wall of the valve element, at least part of said side wall being arranged in abutment with an inner wall of the tubular section of the flange part, said inner wall extending along the axial direction, the valve element defining an inner cavity delimited by a substantially tubular side wall and a substantially closed first end part, the valve element further comprising a second end part arranged opposite the first end part, an opening being arranged at or near the second end part, said opening establishing a fluid connection between the inner cavity and the exterior, wherein the side wall is provided with one or more cut-outs, each cut-out establishing a fluid connection between the inner cavity and the exterior,
wherein the valve element is configured to stretch in response to a force applied along the axial direction of the tubular section, in such a manner that the one or more cut-outs/are moved at least partly out of the tubular section, thereby establishing a fluid connection through the flange part, via the one or more cut-outs, and wherein the valve element is configured to resume a relaxed state, restoring its shape and size, when the force is no longer applied, thereby moving the one or more cut-outs into the tubular section, thereby interrupting the fluid connection through the flange part.

33: The valve of claim 32, wherein the valve element is provided with at least two cut-outs, and wherein the cut-outs are arranged substantially equidistantly on the side wall, along an annular direction.

34: The valve of claim 32, wherein the valve element further comprises a sealing lip arranged between the cut-outs and the first end part.

35: The valve of claim 32, wherein the valve element is made from a resilient material.

36: A container comprising:
(a) valve comprising:
(i) a flange part including a tubular section defining an axial direction; and
(ii) a valve element mounted in the tubular section of the flange part, said valve element being provided with one or more cut-outs formed in a side wall of the valve element, at least part of said side wall being arranged in abutment with an inner wall of the tubular section of the flange part, said inner wall extending along the axial direction,
wherein the valve element is configured to stretch in response to a force applied along the axial direction of the tubular section, in such a manner that the one or more cut-outs are moved at least partly out of the tubular section, thereby establishing a fluid connection through the flange part, via the one or more cut-outs, and wherein the valve element is configured to resume a relaxed state, restoring its shape and size, when the force is no longer applied, thereby moving the one or more cut-outs into the tubular section, thereby interrupting the fluid connection through the flange part; and
(b) a plurality of flexible walls defining an interior of the container and an exterior of the container, said valve being arranged such that said valve defines a fluid passage between the interior of the container and the exterior of the container when the valve is in an open position, and seals the container when the valve is in a closed position.
